(19) United States
(12) Patent Application Publication
(10) Pub. No.: US 2026/0277867 A1
(43) Pub. Date: Sep. 17, 2026

(54) PARALLEL PROCESSING OF LARGE DATA OBJECTS USING SIDECARS

(71) Applicant: AirMettle, Inc., Houston, TX (US)

(72) Inventors: Donpaul C. Stephens, Houston, TX (US); Matthew P. Youill, Victoria (AU); Ernest Villafana Jaramillo, Round Rock, TX (US); Joshua R. Fuhs, Columbus, IN (US); Dean F. Sutherland, Pittsburgh, PA (US)

(21) Appl. No.: 19/566,384

(22) Filed: Mar. 13, 2026

Related U.S. Application Data
(60) Provisional application No. 63/771,367, filed on Mar. 13, 2025.

(51) Int. Cl. G06F 16/22

(52) U.S. Cl. CPC G06F 16/22

(57) ABSTRACT

A technique for managing data objects includes storing a data object in complete form and scanning the data object to generate a sidecar object. The sidecar object identifies an object type of the data object and locations of multiple logical portions of the data object. The technique further includes performing a parallel-processing task on the data object at least in part by identifying the logical portions from the sidecar object and allocating subtasks for the logical portions to respective workers. The workers process the subtasks in parallel to generate partial results. The technique further includes combining the partial results to produce an overall result that represents the data object as a whole.

### CROSS-REFERENCE TO RELATED APPLICATIONS

This application claims the benefit of united sates provisional application no. 63/771,367, filed march 13, 2025, the contents and teachings of which are incorporated by reference herein in their entirety.

### STATEMENT REGARDING FEDERALLY SPONSORED RESEARCH OR DEVELOPMENT

This invention was made with government support under DE-SC0024750 awarded by the U.S. Department of Energy. The government has certain rights in the invention.

### BACKGROUND

Data processing has undergone transformational change with the increased availability of inexpensive processors and storage media. Users now have the option to process and store their data locally, or to store their data on servers connected over a network, in computing clusters, or in the cloud. In addition, cloud computing options include both public cloud and private cloud offerings.

With the era of big data upon us, users may store and process ever more voluminous data objects. For example, it is not uncommon for tabular data, event logs, tree-based data, and audio and/or video data to reach sizes in the gigabyte range or above. Storing and processing such large data objects presents unique challenges.

A prior approach to processing large data objects operates by splitting a data object into multiple portions, transforming the portions into respective individually-processable segments, and storing the segments in nodes of a storage cluster. The storage nodes include compute resources, which are capable of performing data analytics on the locally-stored segments. For example, a gateway may receive a query request, break the query request into sub-tasks, and distribute the sub-tasks to the storage nodes for querying the locally-stored segments. The nodes process the sub-tasks and return results back to the gateway. The gateway combines the results to produce an overall result, which applies to the data object as a whole. Examples of this type of solution are disclosed in the following patent documents:

U.S. Patent No. 11,669,505, issued June 6, 2023, and entitled “PARTITIONING, PROCESSING, AND PROTECTING DATA”;

U.S. Patent No. 12,321,474, issued June 3, 2025 and entitled “PARTITIONING, PROCESSING, AND PROTECTING MEDIA DATA”;

U.S. Patent No. 12,174,815, issued December 24, 2024 and entitled “PARTITIONING, PROCESSING, AND PROTECTING COMPRESSED DATA”; and

U.S. Patent Publication No. 2024/0045872, published February 8, 2024 and entitled “PARTITIONING, PROCESSING, AND PROTECTING MULTI-DIMENSIONAL DATA”.

The contents and teachings of each of the above-listed patent documents are incorporated herein by reference in their entirety.

### SUMMARY

Certain embodiments are directed to a method of managing data objects. The method includes persistently storing a data object in complete form and generating a sidecar object for the data object. The sidecar object identifies an object type of the data object and locations of multiple logical portions of the data object within the data object. The logical portions provide separately processable units of the data object. The method further includes performing a parallel-processing task on the data object, including identifying the logical portions from the sidecar object and assigning multiple workers to respective ones of the logical portions.

Other embodiments are directed to a computerized apparatus constructed that includes control circuitry including a set of processors coupled to memory. The control circuitry is constructed and arranged to access a sidecar object for a data object persistently stored in complete form. The sidecar object identifies an object type of the data object and locations of multiple logical portions of the data object within the data object. The logical portions provide separately processable units of the data object. The control circuitry is further constructed and arranged to coordinate a parallel-processing task on the data object, including identifying the logical portions from the sidecar object and assigning multiple workers to respective ones of the logical portions, and to combine partial results from the workers to produce an overall task result that represents the data object as a whole.

Still other embodiments are directed to a computer program product. The computer program product stores instructions which, when executed on control circuitry of a computerized apparatus, cause the computerized apparatus to perform a method of managing data objects. The method includes accessing a sidecar object for a data object persistently stored in complete form. The sidecar object identifies an object type of the data object and locations of multiple logical portions of the data object within the data object. The logical portions provide separately processable units of the data object. The method further includes coordinating a parallel-processing task on the data object, including identifying the logical portions from the sidecar object and assigning multiple workers to respective ones of the logical portions. The method still further includes combining partial results from the workers to produce an overall task result that represents the data object as a whole.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a block diagram showing logical portions of a data object according to one or more embodiments.

FIG. 3 is a flowchart showing an example method of creating a sidecar object, according to one or more embodiments.

FIG. 4 is a flowchart showing an example arrangement for identifying one or more formats in a data object, according to one or more embodiments.

FIG. 5 is a block diagram of an example sidecar object, according to one or more embodiments.

FIG. 6 is a flowchart of an example method of coordinating parallel-processing tasks, according to one or more embodiments.

FIG. 7 is a block diagram of an example orchestrator, according to one or more embodiments.

FIG. 8 is a flowchart showing an example method of managing data objects, according to one or more embodiments.

### DETAILED DESCRIPTION

The above-described approach for handling large data objects is well-suited for storage clusters having ample compute resources. However, many storage clusters lack sufficiently powerful resources. In addition, some customers would prefer to store a large data object altogether in one service, rather than storing different portions of the data object on different nodes of a storage cluster. Indeed, the abundance of inexpensive cloud storage makes centralized storage particularly attractive. What is needed, therefore, is a parallel-processing solution for large data objects that decouples compute resources from long-term storage locations of the data object or its portions.

To address the above need at least in part, an improved technique includes storing a data object in complete form and scanning the data object to generate a sidecar object. The sidecar object identifies an object type of the data object and locations of multiple logical portions of the data object. The technique further includes performing a parallel-processing task on the data object at least in part by identifying the logical portions from the sidecar object and allocating subtasks for the logical portions to respective workers. The workers process the subtasks in parallel to generate partial results. The technique further includes combining the partial results to produce an overall result that represents the data object as a whole.

Advantageously, the improved technique keeps all the data of the data object together, as many customers prefer. It also avoids the constraint that compute resources must be provided locally to individually-stored segments. To the contrary, the improved technique enables compute resources to be located anywhere, including locally to the data object or remotely, such as in a separate data center or group of data centers.

Embodiments of the improved technique will now be described. One should appreciate that such embodiments are provided by way of example to illustrate certain features and principles but are not intended to be limiting.

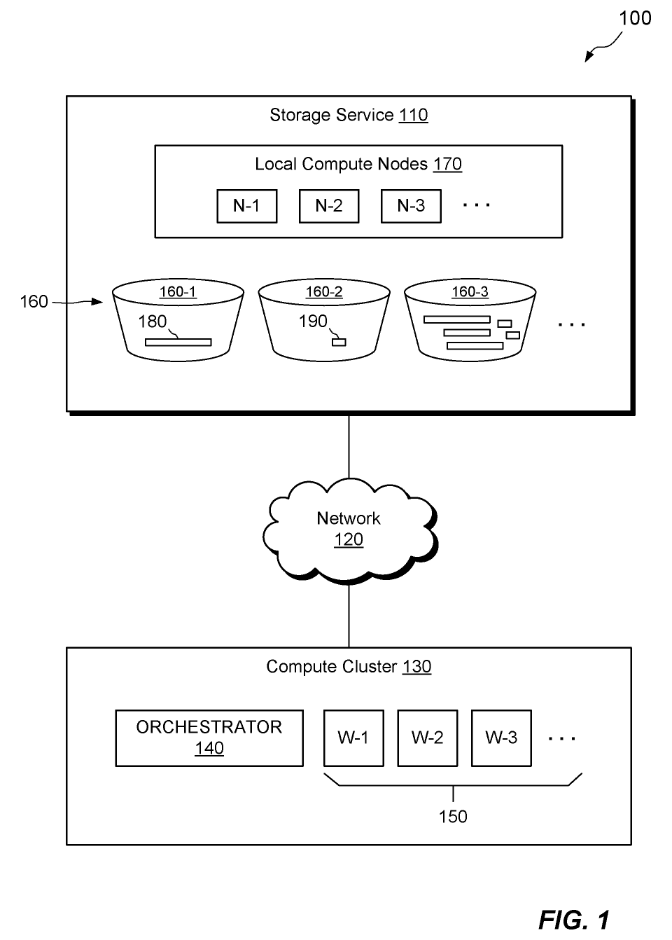

FIG. 1 shows an example environment 100 in which embodiments of the improved technique can be practiced. The environment 100 includes a storage service 110, a network 120, and a compute cluster 130. The storage service 110 may be a public cloud storage service, a private cloud storage service, an on-prem storage service, one or more storage arrays, or any other arrangement of storage resources. The network 120 may be any type of network, such as a local area network (LAN), a wide area network (WAN), the Internet, or some other type of network or combination of networks. The compute cluster 130 includes multiple computing nodes, each with its own processor(s), memory, and network connectivity. The computing nodes of the compute cluster 130 include an orchestrator 140 and multiple workers 150, e.g., workers W-1, W-2, W-b, and so on. As described further below, the orchestrator 140 is arranged to coordinate parallel processing for performing data analytics on certain data stored in the storage service 110, and the workers 150 are arranged to operate in parallel to perform those data analytics. Preferably, the workers 150 are scalable compute nodes configured to automatically increase processing capacity by including additional nodes as needed to handle workloads. The workers 150 may be capable of running as ephemeral workers, i.e., workers that run until their processing tasks are completed and then terminate automatically. Although the orchestrator 140 is shown within the same cluster 130 as the workers 150, the orchestrator 140 may alternatively reside in a separate server or cluster, such as a separately scalable cluster. The example shown is merely for illustration.

According to one or more embodiments, the storage service 110 includes buckets 160, labeled 160-1, 160-2, 160-3, and so on, as well as local compute nodes 170, labeled N-1, N-2, N-3, and so on. The buckets 160 are arranged to store data, such as customer data or other data. Also, the local compute nodes 170 are arranged for executing event routines and other programs related to data in the buckets 160, including serverless programs, such as those available using AWS (Amazon Web Services) Lambda or equivalent. The local compute nodes 170 may be absent in certain embodiments, such as in storage services that do not include local compute nodes 170. Likewise, the compute cluster 130 may be absent in certain embodiments, such as in storage services which provide sufficiently powerful local compute nodes 170.

As further shown in FIG. 1, the bucket 160-1 in the storage service 110 stores a data object 180, which may be arbitrarily large, such as 1 GB (gigabyte) or larger, for example. The data object 180 may be a file or other kind of object and has an object type, also referred to herein as a “format.” Examples of object types for the data object 180 include CSV (Comma-Separated Values) files, JSONL (JavaScript Object Notation Line) files, Parquet files, video files, image files, multidimensional data files, such as NetCDF (Network Common Data Form) and/or HDF5 (Hierarchical Data Format, Version 5) files, and compressed GZIP (GNU Zip) files. Combined object types are also possible, such as GZIP-compressed CSV files, GZIP compressed JSONL files, and so on. In addition, the data object 180 may include nested object types, such as TAR (Tape Archive) file that includes a directory of CSV files, or a TAR file that contains a directory of GZIP-compressed CSV files, for example. The possible object types and combinations of object types are numerous, with the examples above being merely illustrative.

In operation, a user may store the data object 180 in the bucket 160-1. At some point, the user may wish to perform data analytics on the data object 180, such as running a SQL (Structured Query Language) query and/or other analytics, referred to herein as user-defined functions, or “UDFs.”

The data object 180 may be too large to be processed efficiently as a single object. A parallel-processing scheme is proposed herein for handling large objects, in which the data object 180 is logically broken down into separately processable portions. The orchestrator 140 distributes the logical portions to respective workers 150, which process the portions individually and in parallel. The individual workers 150 return portion-specific results to the orchestrator 140, which combines the portion-specific results to produce an overall result that represents the data object 180 as a whole.

According to one or more embodiments, the above parallel processing is facilitated by the use of a sidecar object 190. The sidecar object 190 identifies logical portions of the data object 190, enabling the orchestrator 140 to distribute processing tasks for the logical portions to respective workers 150.

As shown, the sidecar object 190 may be stored in a separate bucket 160-2, rather than in the same bucket 160-1 with the data object 180. For example, the sidecar object 190 may be created by a user or service separate from the owner of the bucket 160-1, such that storing the sidecar object 190 in the separate bucket 160-2 avoids having to grant the user or service write privileges to the bucket 160-1. In addition, storing the sidecar object 190 in a separate bucket 160-2 enables the sidecar object 190 to have the same name as the data object 180, which may be a desirable feature for some users.

The sidecar object 190 may be generated at various times and in response to various actions. For example, the storage service 110 may generate the sidecar object 190 automatically in response to the data object 180 being stored in a specified location, such as in the bucket 160-1. Other examples include the following:

On Demand. The sidecar object 190 is generated in response to an on-demand request, such as a user request.

Upon First Query. The sidecar object 190 is generated in response to receiving a first request to query the data object 180.

Upon Query to Other Object. The sidecar object 190 is generated in response to receiving a first request to query another data object stored in the same bucket 160 with the data object 180.

Specified Criteria. The sidecar object 190 is generated in response to sampling data or content-based metadata of the data object 180, and determining that the data object 180 satisfies a specified set of criteria, such as the data object being of a supported object type.

One should appreciate that the buckets 160 may individually store any number of data objects and/or sidecar objects, such as shown in bucket 160-3. Further, although buckets 160 provide useful containers for storing data objects and sidecar objects, their use is not strictly required, as some embodiments may store data objects and sidecar objects in other containers, such as files in file systems or as binary images in disk partitions. The use of buckets 160 is therefore optional.

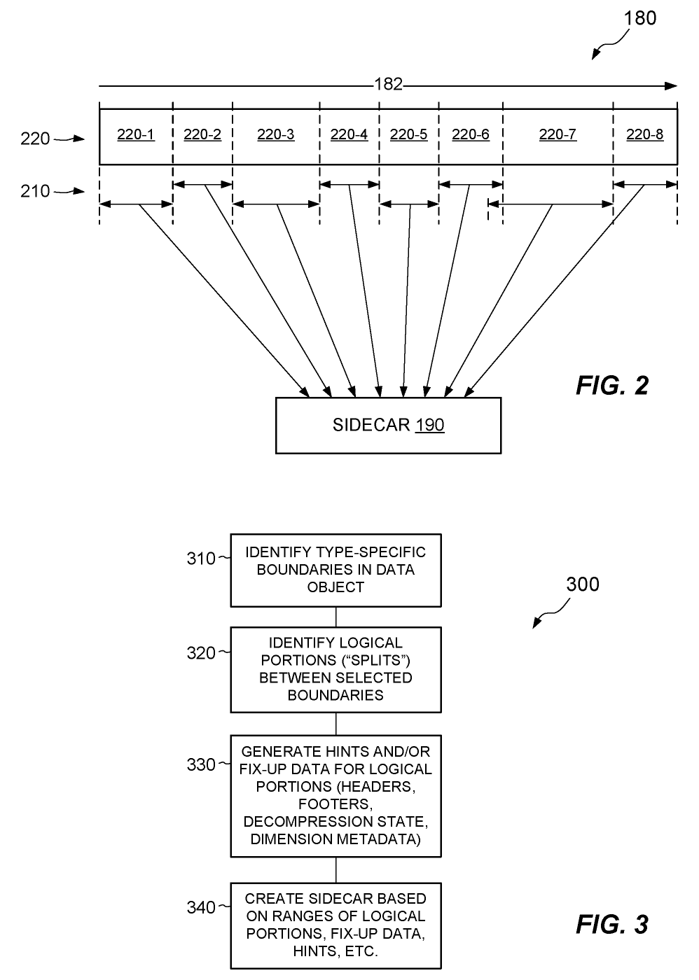

FIG. 2 shows an example arrangement for generating the sidecar object 190 from the data object 180 according to one or more embodiments. FIG. 3 shows an accompanying method 300. The method 300 is typically performed, for example, by the local compute nodes 170 in the storage service 110 and/or by the workers 150 in the compute cluster 130. The various acts of method 300 may be ordered in any suitable way, which may include performing some acts simultaneously.

The method 300 starts at 310, whereupon the data object 180 is scanned to identify selected boundaries 210 (vertical dashed lines) in the data object 180. The selected boundaries 210 identify separate processable units of the data object 180. The selected boundaries 210 are typically a small subset of all boundaries found in the data object 180. Only the subset of boundaries is selected to provide logical portions of appropriate size for efficient parallel processing.

The exact nature of the boundaries may vary from one object type to another. For example, CSV files and JSONL files may use NewLine characters to identify boundaries, whereas video files or streams may use IDR (I-Frame with Decoder Reset) frames. Some object types specify boundaries using embedded metadata. For example, Parquet files contain footers that identify boundaries between adjacent row groups. NetCDF and HDF5 files use dimensional metadata to identify boundaries between different tensors. With GZIP files, boundaries appear at the ends of deflate blocks.

At 320, multiple logical portions 220, also called “splits,” are identified between selected boundaries 210. Eight logical portions 220 are specifically shown (220-1 through 220-8), but typical numbers of logical portions 220 may vary and can be much larger than the number shown.

At 330, hints and/or fix-up data are generated for one or more of the logical portions 220. The hints and fix-up data may be generated during the same scanning operation described above for identifying the selected boundaries, but this is not required. Hints for a logical portion 220 may specify aspects of the logical portion that can be relevant to analytics processing, such as line numbers for CSV/JSONL (enabling range-based queries), coordinates or time/spatial representations for NetCDF/HDF5 (supporting tensor algebra and re-gridding), and high-level statistics (e.g., column quartiles) for early filtering.

Fix-up data includes data and/or metadata that can be added to a logical portion to transform it into an independently processable unit as the same object type as the data object 180. For example, a CSV header can be added to logical portions that contain CSV rows. Parquet footers can be added to logical portions that contain row groups. IDR frames can be added to logical portions that contain video data. A decompression state may be added to logical portions that contain GZIP-compressed data; the decompression state enables GZIP decompression to begin at any logical portion without the need to reference previous portions. Dimensional metadata may be added to logical portions that contain multi-dimensional data. These examples are well-developed in the incorporated U.S. patent documents identified above and need not be repeated here. One should appreciate that the fix-up data for a logical portion enables that portion to be transformed into a complete data object of the same type as the original data object 180. For example, the logical portions may be individually read and processed by software applications designed to read and process data objects of that type.

Some data objects include more than one object type, which may be nested or may appears side-by-side in a directory. In these examples, a data object may include a main, or “outer” object type (such as GZIP), as well as one or more “inner” object types, such as CSV, JSONL, Parquet, etc. In some examples, splitting then occurs based on boundaries formed between portions of inner objects, in place of or in addition to boundaries formed between portions of the main (outer) object. Fixup data and hints may apply to these inner objects, in place of or in addition to fixup data and hints applied to portions of the main object.

At 340, the sidecar object 190 is generated. The generated sidecar object 190 identifies ranges of the logical portions 220. For example, the range of each logical portion 220 is specified as a start offset and an end offset, or as a start offset and a length, within an address range 182 of the data object 180. The sidecar object 190 further includes the hints and/or fix-up data, which may be provided on a per-logical portion basis.

Although FIG. 2 shows contiguous logical portions 220, one should appreciate that certain logical portions 220 may be separated by gaps. In addition, certain logical portions 220 may overlap, as shown in the figure where portion 220-7 includes part of portion 220-6. Thus, portions 220 need not be contiguous or completely independent of one another.

Also, one should appreciate that there is no need for the selected boundaries 110 of the data object 180 to align with storage resources that back the data object 180, such as partitions, storage arrays, or other physical storage resources. For example, logical portions 220 may cross multiple back-end partitions and need not be aligned with such partitions. However, nothing prevents such alignment if it is deemed advantageous by the provider of the storage service 110.

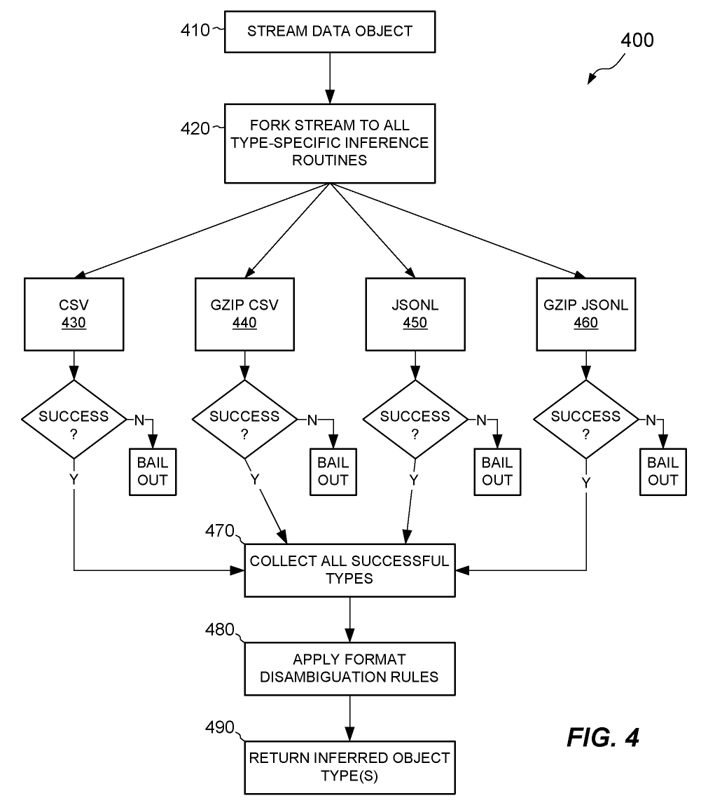

FIG. 4 shows an example method 400 of identifying an object type of the data object 180 according to one or more embodiments. Method 400 may be performed as part of the processing described in method 300, e.g., as part of the same scan of the data object 180. Alternatively, method 400 may be performed independently of method 300.

Method 400 begins at 410, whereupon a stream of the data object 180 is generated. At 420, the stream is forked to multiple type-specific inference routines, such as a CSV inference routine 430, a GZIP CSV inference routine 440, a JSONL inference routine 450, and a GZIP JSONL inference routine 460. Additional inference routines may be provided for additional object types, or combinations of object types. Preferably, inference routines are run in parallel by respective compute nodes, such as local compute nodes 170 and/or workers 150 in the compute cluster 130. The compute nodes or workers may be ephemeral workers that terminate automatically upon completion of their respective tasks.

Each of the inference routines attempts to conclusively determine whether its respective stream of the data object 180 conforms to the particular object type to which the inference routine is dedicated. For example, the CSV inference routine 430 checks for headers and newline characters characteristic of CSV data. If the object type for an inference routine is determined to be present, the result is SUCCESS; otherwise, the result is failure. In some examples, failed results can be determined quickly, and the respective inference routines can terminate early (bail out), thereby freeing the associated compute resources.

At 470, the method 400 collects all successful object types, reflecting the fact that some data objects may include multiple object types. At 480, the method 400 applies disambiguation rules. For example, if only one inference routine succeeds, that inference routine is selected. If multiple inference routines succeed, stricter formats are selected over less strict ones (e.g., JSON over CSV, gzip-JSON over gzip-CSV) based on predefined rules that prioritize semantic fidelity and query efficiency. The parallel inferences of method 400 not only accelerate metadata generation but also correctly resolve ambiguities in mixed or compressed data streams. At 490, after applying the disambiguation rules, the method 400 returns an inferred object type, or multiple object types if greater than one object type is found.

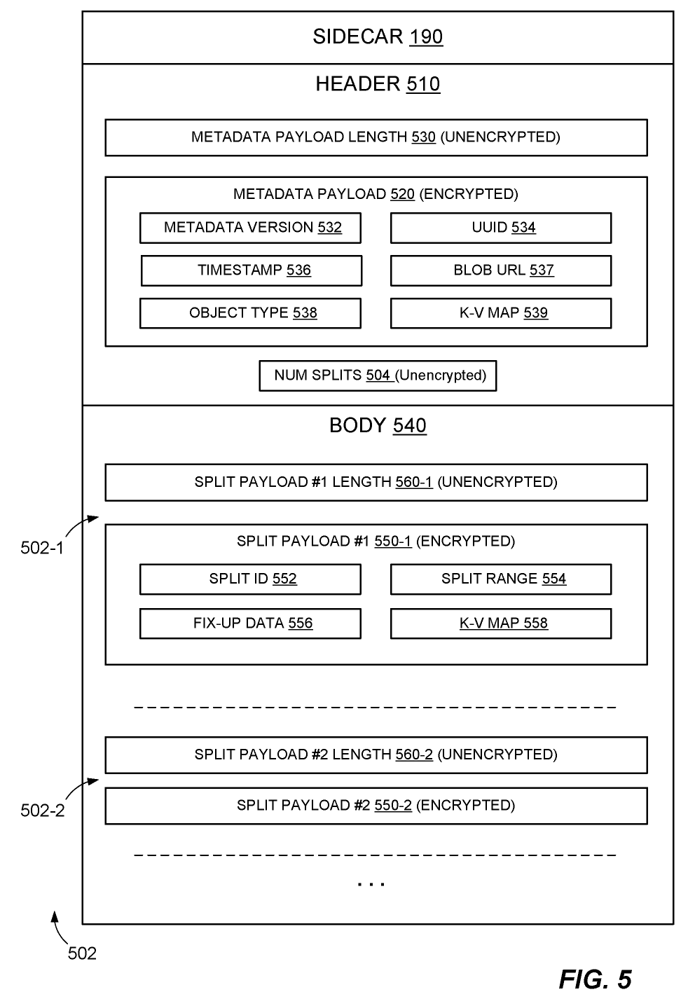

FIG. 5 shows an example layout of the sidecar object 190 according to one or more embodiments. The sidecar object 190 includes a header 510 and a body 540. The header 510 includes a metadata payload 520 and a metadata payload length 530. For example, the metadata payload length 530 is an integer that provides the exact number of bytes in the metadata payload 520, which may begin immediately after the metadata payload length 530. The metadata payload 520 includes metadata that describes the data object 180 as a whole. Examples of such metadata include the following:

Metadata version 532. A version number of the software used to generate the sidecar object 190.

UUID 534. A unique identifier of the data object 180.

Timestamp 536. A date and time that the sidecar object 190 was created.

Blob URL 537. A URL (Uniform Resource Locator) that provides an address of the data object 180, such as an Internet address.

Object Type 538. A code that indicates an object type of the data object 180, or multiple object types if present. Non-limiting examples include "CSV", "JSON", "PARQUET", "NETCDF", "HDF5", "TAR", and "VIDEO".

K-V Map 539. A key-value database that stores information about the data object 180, which may be relevant to parallel processing. May include hints and/or flags that indicate whether particular logical portions can be skipped for certain processing tasks.

The metadata elements listed above are merely examples and are not intended to be limiting.

As further shown in FIG. 5, the header 510 further includes a number of splits 504 (NUM SPLITS), which indicates the number of logical portions 220 recorded in the sidecar object 190. The number of splits 504 is preferably a fixed-length data element, such as 4-bytes long, and is preferably unencrypted.

The body 540 of the sidecar object 190 includes information about specific logical portions 220 (splits). A separate entry 502 may be provided for each split. For example, a first entry 502-1 is provided for the first logical portion 220-1 (FIG. 2) and includes a split payload 550-1 and an associated payload length 560-1, which may be arranged similarly to the metadata payload 520 and the metadata payload length 530 in the header 510. The split payload length 560-1 provides a length in bytes of the immediately following split payload 550-1. The split payload 550-1 includes metadata pertaining to a particular logical portion 220. The split payload 550-1 may include small sequences of the logical portion 220, such as fix-up data, but does not include the entirety of the logical portion 220. In an example, the split payload 550-1 for a logical portion includes the following:

Split ID 552. An identifier of the logical portion (split). The split ID need not be globally unique, only unique to the data object 180.

Split Range 554. A range of the logical portion 220 within the address range 182, such as a starting offset, ending offset, length, etc.

Fix-up Data 556. Any headers, footers, decompression state, or other data or metadata needed to transform the portion 220 into an individually processable unit of data.

K-V Map 558. A key-value database that stores information relevant to the segment, including any of the above-described hints, for example.

A second entry 502-2 may be provided for the second logical portion 220-2. For example, the second entry 502-2 includes a split payload 550-2 and a split payload length 560-2. Additional entries 502 may be provided for additional logical portions 220, such as one entry for each logical portion in the data object 180.

Preferably, the metadata payload 520 and each split payload (550-1, 550-2, and so on) are encrypted, while the metadata payload length 530 and each split payload length (560-1, 560-2, and so on) are unencrypted. The encrypted payloads protect against leakage of potentially revealing information about the data object 180, while the unencrypted payload lengths enable quick access to particular parts of the sidecar object 190, without imposing a requirement to decrypt the entire sidecar object 190. For example, a worker 150 that has been assigned an analytics task involving the second logical portion 220-2 (FIG. 2) may access the sidecar object 190, read the unencrypted metadata payload length 530, skip forward to the first entry 502-1, read the unencrypted split payload length 560-1, and skip forward to the second entry 502-2, where the desired split payload 550-2 can be found. The worker 150 can then decrypt the split payload 550-2 without having to decrypt any other split payloads in the sidecar object 190.

In an example, split payloads (550-1, 550-2, and so on) are encrypted on a per-payload basis, and each split has a unique initialization vector and additional authenticated data (AAD) derived from the size of the split payload. This per-split design ensures that workers 150 can only decrypt the split payloads of the logical portions to which they are assigned, minimizing exposure and aligning with the parallel execution model. AES-256-GCM encryption may be used as a convenient encryption type in some examples.

According to one or more embodiments, the sidecar object 190 can be used to detect errors or tampering. For example, the split payload for each split can be digitally signed using the assigned initialization vector, the encrypted ciphertext of the split payload, and the metadata payload length 530.

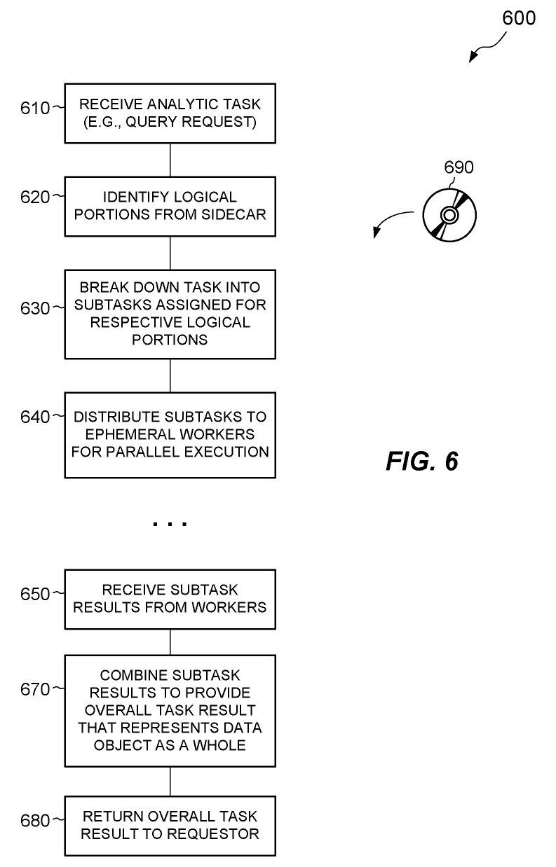

FIG. 6 shows an example method 600 of managing analytics tasks, according to one or more embodiments. The method 600 may be performed, for example, by the orchestrator 140 as shown in FIG. 1. The analytics tasks can take a variety of forms, such as running SQL queries, applying AI (artificial intelligence) algorithms or filters, performing image processing, performing video processing, decompressing data (e.g., for GZIP compressed data), and compiling statistics, to name a few. The various acts of method 600 may be ordered in any suitable way, which may include performing some acts simultaneously.

Method 600 begins at 610, whereupon the orchestrator 140 receives a request to perform an analytics task. The orchestrator 140 may receive the request, for example, from a client or user interested in gaining insight into the data object 180. At 620, the orchestrator 140 accesses the sidecar object 190 and identifies the logical portions 220.

At 630, the orchestrator 140 breaks down the requested tasks into subtasks to be run on respective logical portions 220, such as one subtask per logical portion. Taking the example of a query, the orchestrator 140 may compile the query into a directed acyclic graph (DAG) of typed operators. The DAG is partitioned into stages at data-redistribution boundaries, such as GROUP BY, ORDER BY, or hash joins, ensuring that intra-stage operations can execute independently. The orchestrator 140 extracts subtasks for each stage and generates portion-specific tickets. The tickets enable workers 150 to access their assigned portions, and a different ticket may be provided for each portion. In an example, the tickets abstract the specifics of the storage service 110—whether third-party cloud, on-premise, or private-cloud—and encapsulate credentials, addressing information, byte ranges, and decryption keys, as needed.

At 640, the orchestrator 140 dispatches subtasks and tickets to workers 150 for parallel execution. In an example, dispatching subtasks to workers is itself performed in parallel, with the orchestrator 140 coordinating with workers 150 using DNS-based service resolution or similar mechanisms for worker discovery.

When a worker 150 receives a subtask, the worker accesses the sidecar object 190 and reads the metadata payload for its assigned logical portion 220. The worker may check for hints (e.g., in a K-V Map) which would enable the worker to preemptively prune its workload or even to disregard the subtask, e.g., if the hints indicate that the logical portion contains no data that is relevant to the subtask. Assuming processing continues, the worker obtains the assigned logical portion 220, e.g., directly from the data object 180. The worker 150 then applies fixup data 556 (e.g., headers, footers, resumption points, etc.) as needed to transform the logical portion into a self-contained object. The worker 150 then executes the subtask’s operator pipeline (e.g., scan → filter → project → partial aggregate) and returns compact partial results to the orchestrator 140.

At 650, the orchestrator 140 receives the subtask results from the workers 150. At 670, the orchestrator 140 combines the subtask results to provide an overall task result that represents the data object 180 as a whole. At 680, the orchestrator 140 returns the overall task result to the requesting client.

Continuing with the querying example above, each worker may compute a partial aggregate (e.g., partial SUM, partial COUNT, partial AVG) over its assigned portion, sending only compact summaries to the orchestrator 140, which performs the final merge. This arrangement minimizes data transfer and leverages the parallel nature of the system.

For multi-stage operations, data shuffling may be coordinated among workers to support complex queries: for GROUP BY, hash-partitioning redistributes data; for ORDER BY, boundaries are predefined by the orchestrator 140; for hash joins or multi-dimensional operations, internal joins utilize similar shuffling mechanisms.

For workloads comprising SQL queries, the typed operators can map directly to SQL constructs: scan for table access, filter for WHERE clauses, project for SELECT expressions, partial aggregate for SUM/COUNT, and shuffle for GROUP BY. Shuffling may involve redistributing certain data among workers 150 to facilitate certain queries or UFDs. UDFs are supported as first-class operators, allowing custom logic to be applied to segments—for example, image processing UDFs on TAR sub-files. Mixed-data scenarios are handled seamlessly: in a gzip-TAR containing heterogeneous sub-files, the orchestrator 140 dispatches different operator pipelines for different logical portions within the same query session (e.g., SQL on JSON sub-files and UDFs on image sub-files), with the sidecar objects directory metadata guiding the routing.

In some examples, the method 600 may be embodied as a computer program product including one or more non-transient, computer-readable storage media 690, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like. Any number of computer-readable media may be used. The media may be encoded with instructions which, when executed on one or more computers or other processors, perform the process or processes described herein. Such media may be considered articles of manufacture or machines, and may be transportable from one machine to another.

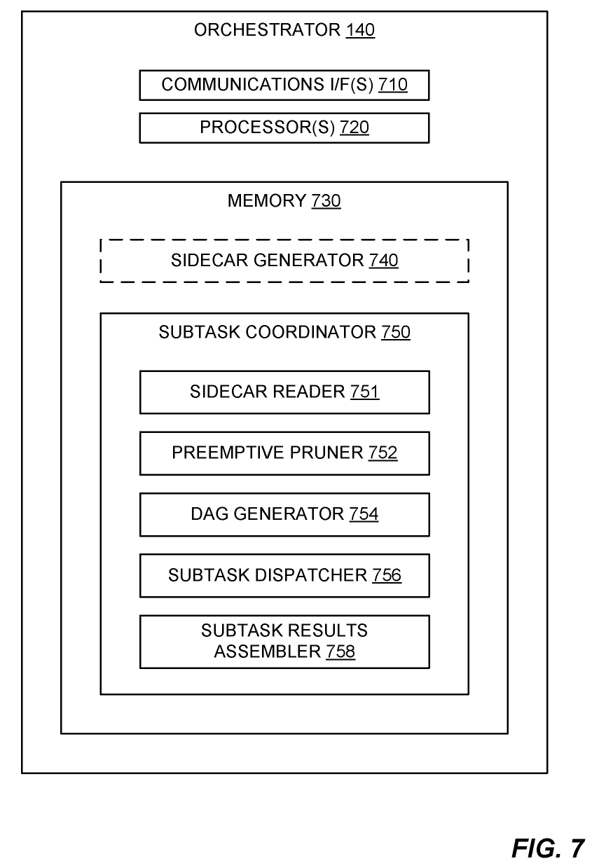

FIG. 7 shows the orchestrator 140 in additional detail, according to one or more embodiments. Although FIG. 7 shows the orchestrator 140 as a single computer, one should appreciate that the orchestrator 140 may be implemented using a scalable computing resource that may include multiple computers.

As shown, the orchestrator 140 includes one or more communication interfaces 710, a set of processors 720, and memory 730. The communication interfaces 710 include, for example, one or more network interface adapters for converting electronic and/or optical signals received over the network 120 to electronic form for use by the orchestrator 140. The set of processors 720 includes one or more processing chips and/or assemblies, such as numerous multi-core CPUs (central processing units). The memory 730 includes both volatile memory, e.g., RAM (Random Access Memory), and non-volatile memory, such as one or more ROMs (Read-Only Memories), disk drives, solid state drives, and the like. The set of processors 720 and the memory 730 together form control circuitry, which is constructed and arranged to carry out various methods and functions as described herein. Also, the memory 730 includes a variety of software constructs realized in the form of executable instructions. When the executable instructions run on the set of processors 720, the set of processors 720 carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 730 “includes,” i.e., realizes by execution of software instructions, a sidecar generator 740 and a subtask coordinator 750. The sidecar generator 740 is configured to generate the sidecar object 190 for the data object 180, e.g., in the manner described in connection with FIGS. 3 and 4. One should appreciate, though, that the sidecar generator 740 may alternatively be implemented by one or more of the local compute nodes 170 of the storage service 110, or by other computers.

The subtask coordinator 750 is configured to implement the method 600 of FIG. 6. To this end, the subtask coordinator 750 may include the following components:

Sidecar reader 751. A component that reads portions of the sidecar object 190, such as the header 510.

Preemptive pruner 752. A component that checks hints in the sidecar object 190 to determine whether processing for any logical portions 220 can be skipped.

DAG generator 754. A component that generates DAGs for analytics tasks.

Subtask dispatcher 756. A component that dispatches subtasks to workers 150.

Subtask results assembler 758. A component that merges partial subtask results to produce overall results that apply to the data object 180 as a whole.

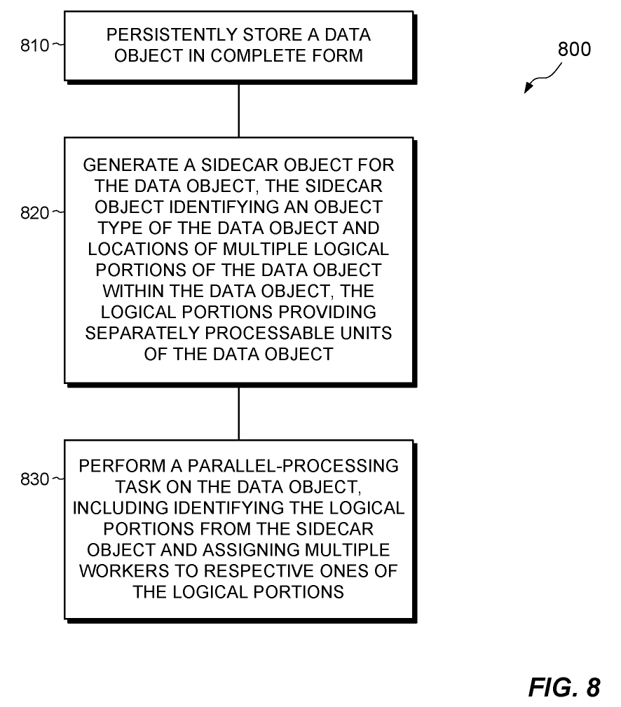

FIG. 8 shows a method 800 of managing data objects according to one or more embodiments and provides an overview of some of the features described above. One should appreciate that the various acts of method 800 may be ordered in any suitable way, which may include performing some acts simultaneously.

At 810, a data object 180 is persistently stored in complete form. For example, a user of the storage service 110 may perform user-interface actions to store the data object 180 in a bucket, such as bucket 150-1. In some arrangements, the data object 180 may be actively stored. i.e., in an active process of writing the data object 180 to persistent storage. In other arrangements, however, the data object 180 may have been stored previously, e.g., by a user, service, or other entity. In such arrangements, “persistently storing” refers to a state of being of the data object 180, i.e., the fact the data object 180 is being persistently stored, rather than to an explicit act that causes the data object 180 to be stored.

At 820, a sidecar object 190 is generated for the data object 180, such as by the local compute nodes 170, the workers 150, or the orchestrator 140. The sidecar object 190 identifies an object type 538 of the data object 180 and locations 554 of multiple logical portions 220 within the data object 180. The logical portions 220 provide separately processable units of the data object 180. In some arrangements, the sidecar object 190 is generated after the data object 180 has been completely stored. In other arrangements, however, the sidecar object 190 is generated while the data object 180 is itself being stored. For example, the data object 180 may be streamed into an interface that forks the stream both to a bucket 150 for persistent storage and to components that perform the methods of FIGS. 2-4. In this manner, both the data object 180 and the sidecar object 190 could be stored in their respective locations as part of a single procedure.

At 830, a parallel processing task is performed on the data object 180. Performing the parallel processing task includes identifying the logical portions 220 from the sidecar object 190 and assigning multiple workers 150 to respective ones of the logical portions 220. For example, the orchestrator 140 coordinates with the workers 150 to perform the parallel processing task, e.g., by directing the workers 150 to execute subtasks, receiving subtask results, and merging the subtask results to provide an overall result that represents the data object 180 as a whole.

An improved technique has been described for managing data objects. The technique includes storing a data object 180 in complete form and scanning the data object 180 to generate a sidecar object 190. The sidecar object 190 identifies an object type (e.g., 538) of the data object 180 and locations (e.g., 554) of multiple logical portions 220 of the data object 180. The technique further includes performing a parallel-processing task on the data object 180 at least in part by identifying the logical portions 220 from the sidecar object 190 and allocating subtasks for the logical portions 220 to respective workers 150. The workers 150 process the subtasks in parallel to generate partial results. The technique further includes combining the partial results to produce an overall result that represents the data object as a whole.

### Examples

EXAMPLE 1: A computer-implemented method of generating metadata for parallel processing of a data object stored in a third-party object storage service, the method including: streaming data chunks of the data object from the object storage service directly into a serverless compute function without storing the entire data object locally; within the serverless compute function, forking a plurality of child processes to concurrently infer one or more data formats from the streamed data chunks; applying disambiguation rules to the concurrent inference results to select a single data format and generate a sidecar metadata object; and storing the sidecar metadata object in association with the data object in the object storage service.

EXAMPLE 1A: The sidecar metadata object is generated in response to an on-demand request from a client, a first query directed to the data object, or a hybrid combination thereof.

EXAMPLE 1B: The sidecar metadata object is generated automatically for all new objects written to a registered bucket in the object storage service.

EXAMPLE 1C: The sidecar metadata object is generated only for objects meeting one or more predefined criteria, including but not limited to recognizable data formats.

EXAMPLE 1D: The plurality of child processes includes separate parsers for at least CSV, JSON, gzip-CSV, and gzip-JSON formats, and the disambiguation rules prefer the stricter format when multiple parsers succeed (e.g., JSON over CSV).

EXAMPLE 1E: The method further includes generating sidecar metadata for complex container formats including TAR files and gzip-compressed TAR files, wherein the sidecar includes directory structure information identifying sub-files and their byte offsets.

EXAMPLE 1F: The sidecar metadata object includes a lightweight header that is readable without decryption and encrypted body data for the splits.

EXAMPLE 2: A non-transitory computer-readable sidecar metadata object stored in or adjacent to a client-controlled object storage bucket and associated with a data object in the bucket, the sidecar metadata object including: a header portion containing at least a format identifier, a version identifier, and an object reference; and a plurality of encrypted or unencrypted split records, each split record specifying at least a byte range within the associated data object, format-specific reconstruction data (including headers and/or footers), and pre-computed processing hints, wherein the sidecar metadata object logically partitions the associated data object into independently processable segments without any modification to the data object itself.

EXAMPLE 2A: The split records are encrypted using per-split AES-256-GCM with a unique initialization vector and additional authenticated data derived from the ciphertext size.

EXAMPLE 2B: The split records are unencrypted.

EXAMPLE 2C: The pre-computed processing hints include GZIP resumption headers, and the system is configured to use alternating or on-demand selected resumption points such that a preceding split can continue decompression into the next.

EXAMPLE 2D: The data object is a TAR or gzip-compressed TAR file, and the split records include directory structure metadata identifying sub-files, their types, and byte offsets within the container.

EXAMPLE 2E: The data object includes video data, and the split records identify IDR (I-Frame with Decoder Reset) locations to enable parallel AI inference or playback.

EXAMPLE 2F: The sidecar metadata object further includes a queryable flag per split that allows an orchestrator to prune splits before any data is retrieved from the object storage service.

EXAMPLE 2G: The sidecar is stored with a hidden prefix in the client’s own bucket such that the client retains full lifecycle management and can delete the sidecar at any time.

EXAMPLE 3: A computer-implemented method of executing an analytical workload on a data object stored in a third-party object storage service, the method including: reading a sidecar metadata object associated with the data object; compiling the analytical workload into a directed acyclic graph (DAG) of typed operators, the DAG being partitioned into stages at data redistribution boundaries; extracting sub-plans from the DAG and generating polymorphic segment tickets for each stage; dispatching the sub-plans and segment tickets to a plurality of ephemeral compute nodes for parallel execution; and receiving and combining partial results from the ephemeral compute nodes into a final result.

EXAMPLE 3A: The analytical workload comprises a SQL query, and the typed operators include at least scan, filter, project, partial aggregate, and shuffle operators.

EXAMPLE 3B: The analytical workload comprises one or more user-defined functions (UDFs) executed on segments of the data object.

EXAMPLE 3C: The data object is a TAR or gzip-compressed TAR file containing heterogeneous sub-files, and the method executes different operator pipelines on different sub-file types within the same query session (e.g., SQL on JSON sub-files and UDFs on image sub-files).

EXAMPLE 3D: The combining step uses two-phase aggregation in which each ephemeral node computes partial aggregates and the orchestrator performs the final merge.

EXAMPLE 3E: The ephemeral compute nodes are serverless functions (e.g., Lambda) or dynamically scaled fixed clusters, and the method supports both in the same deployment.

EXAMPLE 3F: The method further includes coordinating data shuffling among the ephemeral nodes for multi-stage operations including GROUP BY, ORDER BY, and hash joins.

EXAMPLE 4: A system for on-demand parallel analytics of data objects, including: one or more client-controlled third-party object storage buckets containing unmodified data objects; a metadata service that generates and stores sidecar metadata objects in or adjacent to the client-controlled buckets; an orchestrator service that, in response to an authenticated query from a client, reads a sidecar metadata object and dispatches parallel processing tasks to a set of ephemeral compute resources using the sidecar; and wherein the data objects remain under the exclusive lifecycle management, cost control, and access control of the client, and the analytics provider maintains no standing compute cluster and performs no data movement or storage integration.

EXAMPLE 4A: Client authentication is performed on a per-API-call basis using a service-managed API key, and storage credentials are never passed by the client but are retrieved by the orchestrator from a secure database.

EXAMPLE 4B: The sidecar metadata object can be deleted by the client at any time, after which the system falls back to generating a new sidecar on the next query.

EXAMPLE 4C: The ephemeral compute resources include serverless functions and the system supports dynamic scaling of a processing cluster on demand.

EXAMPLE 4D: The system further includes pruning of unnecessary splits by the orchestrator prior to dispatching any tasks, based on pre-computed hints in the sidecar.

EXAMPLE 4E: The system is cloud-agnostic and the polymorphic segment tickets abstract the specific object storage provider (AWS S3, Azure Blob, etc.).

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of managing data objects, comprising:
persistently storing a data object in complete form;
generating a sidecar object for the data object, the sidecar object identifying an object type of the data object and locations of multiple logical portions of the data object within the data object, the logical portions providing separately processable units of the data object; and
performing a parallel-processing task on the data object, including identifying the logical portions from the sidecar object and assigning multiple workers to respective ones of the logical portions.

2. The method of claim 1, wherein generating the sidecar object includes providing additional data and/or metadata in connection with one or more of the logical portions to enable said one or more logical portions to be processed independently of other logical portions.

3. The method of claim 2, wherein providing the additional data and/or metadata enables said one or more logical portions to be processed independently as objects of a same object type as the data object.

4. The method of claim 2, wherein identifying the object type when generating the sidecar object includes executing multiple scans of the data object in parallel, the scans including one scan for each of a plurality of expected data-object types.

5. The method of claim 2, wherein generating the sidecar object is performed in response to storing the data object in a specified storage location.

6. The method of claim 2, wherein the data object is stored in a bucket along with other data objects, and wherein generating the sidecar object is performed in response to receiving a first request to query any of the other data objects in the same bucket.

7. The method of claim 2, wherein generating the sidecar object is performed in response to an on-demand request to generate the sidecar object.

8. The method of claim 2, wherein generating the sidecar object is performed in response to receiving a first request to query the data object.

9. The method of claim 2, wherein generating the sidecar object is performed in response to determining, based on a sampling of the data object, that the data object satisfies a specified set of criteria.

10. The method of claim 2, wherein generating the sidecar object includes storing a respective set of hints in connection with a set of the logical portions, the set of hints for a logical portion indicating whether the logical portion is to be processed or skipped when performing the parallel processing task.

11. The method of claim 2, wherein persistently storing the data object includes saving the data object in a first bucket in a cloud-based storage system, and wherein the method further comprises persistently storing the sidecar object in a second bucket of the cloud-based storage system separate from the first bucket.

12. The method of claim 11, wherein the sidecar object has a same name as the data object.

13. The method of claim 2, wherein the workers to which the subtasks are assigned are ephemeral compute nodes that execute sub-tasks on respective logical portions and terminate upon completion.

14. The method of claim 13, wherein the ephemeral compute nodes are part of a cluster of compute nodes that scale automatically based on computing demands.

15. The method of claim 1, wherein assigning multiple workers to respective ones of the logical portions includes restricting access by the workers to only the logical portions to which they are assigned.

16. A computerized apparatus, comprising control circuitry that includes a set of processors coupled to memory, the control circuitry constructed and arranged to:
access a sidecar object for a data object persistently stored in complete form, the sidecar object identifying an object type of the data object and locations of multiple logical portions of the data object within the data object, the logical portions providing separately processable units of the data object; and
coordinate a parallel-processing task on the data object, including identifying the logical portions from the sidecar object and assigning multiple workers to respective ones of the logical portions; and
combine partial results from the workers to produce an overall task result that represents the data object as a whole.

17. The computerized apparatus of claim 16, wherein the control circuitry constructed and arranged to coordinate the parallel-processing task is further constructed and arranged to preemptively prune a computational workload associated with at least one of the logical portions.

18. The computerized apparatus of claim 16, wherein the control circuitry constructed and arranged to coordinate the parallel-processing task is further constructed and arranged to restrict access by the workers to only the logical portions of the data object to which they are assigned.

19. A computer program product including a set of non-transitory, computer-readable media having instructions which, when executed by control circuitry of a computerized apparatus, cause the computerized apparatus to perform a method of managing data objects, the method comprising:
accessing a sidecar object for a data object persistently stored in complete form, the sidecar object identifying an object type of the data object and locations of multiple logical portions of the data object within the data object, the logical portions providing separately processable units of the data object; and
coordinating a parallel-processing task on the data object, including identifying the logical portions from the sidecar object and assigning multiple workers to respective ones of the logical portions; and
combining partial results from the workers to produce an overall task result that represents the data object as a whole.

20. The computer program product of claim 19, wherein coordinating the parallel-processing task includes preemptively pruning a computational workload associated with at least one of the logical portions.

21. The computer program product of claim 19, wherein coordinating the parallel-processing task includes restricting access by the workers to only the logical portions of the data object to which they are assigned.
